(19) United States
(12) Patent Application Publication
(10) Pub. No.: US 2005/0220945 A1
(43) Pub. Date: Oct. 6, 2005

(54) Shaped Chip-Type Snack

(76) Inventor: Charles C. Romaniuk, Agoura Hills, CA (US)

Correspondence Address: CHARLES C. ROMANIUK, P.O. BOX 1375, AGOURA HILLS, CA, 91376, US

(21) Appl. No.: 10/708,884

(22) Filed: Mar. 30, 2004

(51) Int. Cl. B23B 35/00

(52) U.S. Cl. 426/143

(57) ABSTRACT

A shaped chip-type snack comprising excluded portions that form holes, notches, and sides. Chips can include combinations of hole, notches, and sides. Holes are preferably the size of an average human adult finger, an average child finger, or larger than a finger. The holes, notches, and sides can be any desired shape, including geometric and non-geometric shapes. Any type of chip can be used. Chips are preferably made from any edible material.

### BACKGROUND OF INVENTION

Snack chips have evolved over the years and have improved proved in quality as manufacturing and fabrication methods have improved. The manufacturing of some snack chips has advanced to the point where snack chips of uniform thickness and shape can be produced, such as shown in FIG. 1. These uniform chips are ideally suited for compact and efficient packaging, and can be packaged in a storage container as a stack of chips.

Snack chips are delivered and sold in highly efficient and sanitary packages. As shown in FIG. 2, some packages are sold as a readily manufacturable round tubular container, such as Pringles brand potato snacks manufactured by the Proctor & Gamble Company. These snack chips are manufactured with a unique shape that allows compact storage in the packaging. As a result, the snack chips have a highly space efficient package. However, this packaging inhibits the ease of access to the snack chips by someone who wishes to consume the snack chips. To access the chips from the open storage container, a consumer must pour the contents (or a semi-controlled portion of) out. As a result, the efficiency of the packaging has no benefit to the consumer during use. If too many chips come out of the package, the consumer must eat the chips or spend time putting them back into the package container. Retrieving individual snack chips from the package is possible from a full container. However, access to individual chips becomes increasingly more difficult and requires dexterity as the snack chips are removed. Once a consumer must place their entire hand into the container, it becomes difficult to grasp the chips. In order to increase the ease of access to the snack chips, while maintaining an efficient package, the snack chip must be modified. It is therefore an object of the invention to provide a snack chip shape that allows increased ease of access to individual chips in the efficient package.

### SUMMARY OF INVENTION

The invention describes a snack chip with physical features that allow access to individual chips from an efficent storage package.

The invention describes a chip-type snack product that has a shape that allows a consumer to access individual chips from a storage container without requiring the removal of a large quantity of the contents, thereby minimizing effort, spillage, and mess. The invention describes pre-selected portions of a chip that are excluded from the chip shape to form holes, notches, and sides. Triangular, rectangular, elliptical, polygonal, and non-geometric shaped excluded portions are described. The pre-selected portions are preferably at least finger sized.

The invention is most suitable to, but not limited to, uniform chips that are stacked and packaged in space efficent storage containers.

### BRIEF DESCRIPTION OF DRAWINGS

FIG. 1 is an image of a prior art chip-type snack;

FIG. 2 is a schematic diagram of a prior art tubular chip package;

FIG. 3 is a plan top view of an exemplary embodiment of the invention where an oval chip has a central circular hole;

FIG. 4 is a plan top view of an exemplary embodiment of the invention where a chip has an offset circular hole;

FIG. 5 is a plan top view of another exemplary embodiment of the inventions where a chip has a central rectangular hole;

FIG. 6 is a plan top view of another exemplary embodiment of the invention where a chip has a central triangular hole;

FIG. 7 is a plan top view of another exemplary embodiment of the invention where a chip has an elliptical hole;

FIG. 8 is a plan top view of another exemplary embodiment of the invention where a chip has a laterally oriented rectangular hole;

FIG. 9 is a plan top view of another exemplary embodiment of the invention where a chip has two holes;

FIG. 10 is a plan top view of another exemplary embodiment of the invention where a chip has a circular notch;

FIG. 11 is a plan top view of another exemplary embodiment of the invention where a chip has two triangular notches;

FIG. 12 is a plan top view of another exemplary embodiment of the invention where a chip has a longitudinal side excluded;

FIG. 13 is a plan top view of another exemplary embodiment of the invention where a chip has two lateral sides excluded;

FIG. 14 is a plan top view of another exemplary embodiment of the invention where a chip has a triangular notch and a central circular hole;

FIG. 15 is a plan top view of another exemplary embodiment of the invention where a triangular chip has a triangular notch;

FIG. 16 is a plan top view of another exemplary embodiment of the invention where a triangular chip has two circular notches;

FIG. 17 is a plan top view of another exemplary embodiment of the invention where a triangular chip has a central triangular hole;

FIG. 18 is a plan top view of another exemplary embodiment of the invention where a rectangular chip has a central circular hole and a rectangular corner notch;

FIG. 19 is a plan top view of another exemplary embodiment of the invention where a rectangular chip has two circular notches; and

FIG. 20 is a plan top view of another exemplary embodiment of the invention where a diamond chip has a blunt point in accordance with the invention.

### DETAILED DESCRIPTION

The invention describes a fabricated chip-type snack product including potato chips, crackers, crisps, and wafers (hereafter referred to as a chip) ergonomically shaped to human fingers so an individual chip can be grasped, manipulated, and removed from a stack of chips in a storage container. The invention describes a number of holes, notches, and shapes that allow a chip to be grasped and manipulated by one, two, or more fingers.

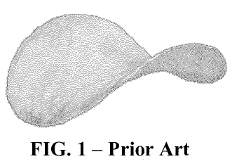

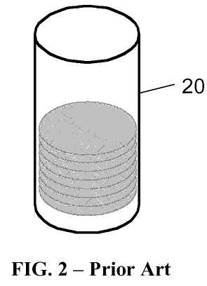

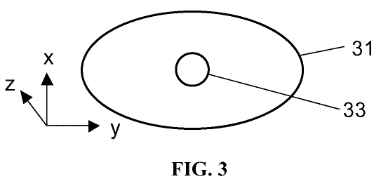

In an exemplary embodiment of the invention, a pre-selected portion of an oval shaped chip 31 is excluded to form a central hole 33, as shown in FIG. 3. The central hole 33 can be formed by removing the pre-selected portion after the chip has been sliced and initially prepared or after the chip has been formed from dough. Alternatively, the pre-selected portion can be incorporated into a die or a cutter used in stamping or pressing a chip or multiple chips. The pre-selected portion can also be incorporated into a mold employed in forming a chip or multiple chips. In this embodiment, the hole 33 is preferably circular in shape and preferably 1.5 cm in diameter to allow an average human adult finger to enter the hole. The hole is preferably the size of the diameter of an average human adult finger, but can be smaller allowing the use of a fingertip, finger pad, or fingernail to access the chip. The hole is preferably placed in the center of the chip so that the chip is symmetrical about lateral (x), longitudinal (y), and vertical (z) axes. The chip is preferably composed of any edible material, such as, but not limited to: potato, legume, vegetable, wheat, corn, nuts, chocolate, candy, and soy. In this embodiment, a single finger can be used to retrieve an individual chip or several chips from a tubular storage container 20, shown in FIG. 2. In this embodiment, the chips and the storage container are circular in overall shape, allowing the chips to be efficiently stacked in the storage container. The chips specifically have a saddle shape, as shown in FIG. 1, and are uniform in shape.

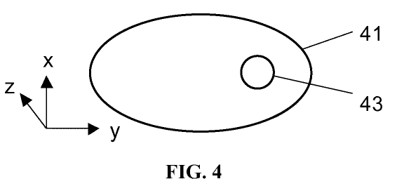

The hole is preferably in the center of the chip, but can be placed anywhere in the chip. In another exemplary embodiment, a circular hole 43 is offset to one side of an oval shaped chip 41, as shown in FIG. 4, to allow a finger to engage the chip without requiring substantial finger bending. In this embodiment, the chip is symmetrical about longitudinal (y) and vertical (z) axes.

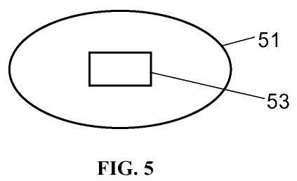

In all of the previously described embodiments, the hole itself can also have a variety of shapes. The hole can be circular to match the shape of a finger or rectangular to offer a larger access area. In another exemplary embodiment, a pre-selected portion is excluded from a chip 51 to form a rectangular hole 53, as shown in FIG. 5. The hole 53 provides a larger access area for a finger to engage the chip. In this embodiment, the hole 53 measures 1 cm by 2 cm and has an area of 2 cm².

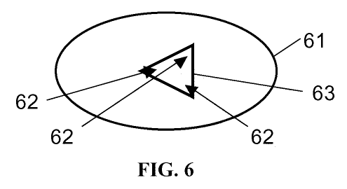

In another exemplary embodiment, a triangular shaped hole 63, as shown in FIG. 6, is employed in a chip 61 and forms three compression areas 62. As a finger is dragged across the surface of the chip and engages the triangular hole, the skin of the finger pad is compressed by two sides of the triangular hole, in the compression areas 62, and the pressure of the skin retains the chip in (situ) position on the finger. The finger can also engage the chip by one side of the hole 63.

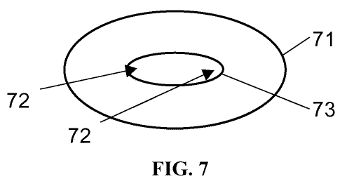

The features of the previous embodiments can be combined in an elliptical shape to provide a large access area of the rectangular shape and a compression area of the triangular design. In another exemplary embodiment of the invention, an elliptically shaped pre-selected portion of an oval shaped chip 71 is excluded, as shown in FIG. 7, to form an elliptical hole 73. The elliptical shape provides a large finger area for increased access and a compression area 72 at each end of the hole.

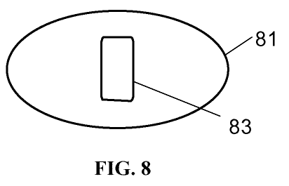

Since a person can rotate their hand to engage the hole in the chip, the hole or holes in all of the exemplary embodiments can be oriented in any direction on the chip, including laterally, longitudinally, diagonally, and any angle in between. For elongated hole shapes, such as elliptical and rectangular, the hole is preferably oriented longitudinally for greater strength, as shown in FIG. 5, or laterally for greater access. In another exemplary embodiment of the invention, a pre-selected portion in the shape of a rectangle is excluded in a chip 81 to form a rectangular hole 83, as shown in FIG. 8. The hole is oriented laterally in this embodiment. The rectangular hole 83 preferably has rounded corners in this embodiment.

Hole shapes that reflect the chip shape, as well as shapes with fewer sharp corners, can offer improved structural chip integrity and strength. Rounded corners are also preferred for all hole shapes to provide structural integrity. Hole shapes are not limited to these example shapes, but can be polygonal, such as pentagons, hexagons, octagons, etc., or any other desired geometric or nongeometric shape including letters, words, images, symbols, and icons.

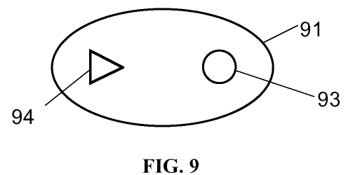

Multiple holes can also be used to allow a choice for engaging the chip and to allow multiple fingers to engage the chip. In another exemplary embodiment, two pre-selected portions are excluded to form two holes 93, 94 on opposite ends of a chip 91, as shown in FIG. 9. One hole is circular and one hole is triangular. In this embodiment, both holes are preferably fingertip size. Holes can be placed anywhere on the chip.

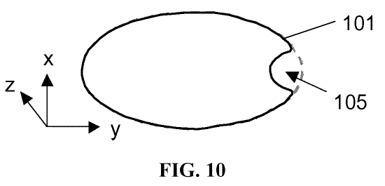

In another exemplary embodiment of the invention, a pre-selected portion of an oval chip 101 is excluded to form a notch 105, as shown in FIG. 10. In this embodiment, the notch is circular to fit a human finger and is the approximate size of a human adult finger. The notch 105 can have any shape, such as, but not limited to, triangular, circular, elliptical, rectangular, polygonal, geometric, and non-geometric. As well, the chip is symmetrical about longitudinal (y), and vertical (z) axes. In this embodiment, the notch is located on a longitudinal end of the chip. However, the notch is not limited to an end position and can be located anywhere on the chip. In FIGS. 10-16 and FIGS. 18-20, dotted lines indicate the original shape of the chip before the pre-selected portion(s) have been removed.

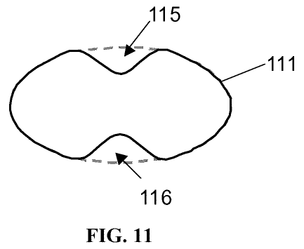

Multiple notches can also be utilized to provide direct engagement by two or more fingers. In another exemplary embodiment of the invention, as shown in FIG. 11, pre-selected portions of a chip shape are excluded to form two notches 115, 116 on opposite sides of a chip 111. Multiple notches are preferably located on opposite sides of the chip, or on perpendicular sides, to allow full grasping of the chip. However, multiple notches can be located on the same side of the chip to allow the chip edge to be grasped. The notches are preferably the approximate size of a human adult finger, but can be smaller to accommodate a fingertip or fingernail, or larger to accommodate more than one finger. In this embodiment, the notches 115, 116 are triangular in shape.

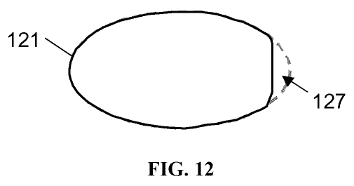

Pre-selected portions encompassing a side of a chip can also be excluded and may reduce any fracturing of chip extremities that could occur. In another exemplary embodiment of the invention, a pre-selected portion 127 of a chip 121, comprising a side of the chip, is excluded, as shown in FIG. 12. The excluded portion 127 is preferably the size of an adult finger or fingertip. Similar to previous embodiments, the excluded portion can have any shape. In this embodiment, a longitudinal side of the chip 121 is excluded.

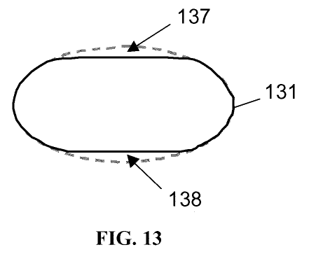

In another exemplary embodiment, as shown in FIG. 13, multiple sides 137, 138 of a chip 131 are excluded to allow multiple fingers to grasp the chip 131. In this embodiment, two lateral sides of the chip 131 are excluded to allow multiple fingers to engage the chip.

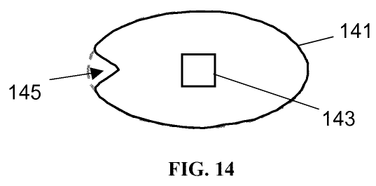

The shapes described above can also be combined to provide additional accessibility to a consumer. In another exemplary embodiment of the invention, pre-selected portions of a chip 141 are excluded to form a triangular notch 145 and a rectangular central hole 143, as shown in FIG. 14. The rectangular hole 143 preferably measures 1 cm by 1 cm and has an area of 1 cm . Providing multiple methods of access can allow a large finger, multiple fingers, or a consumer with limited finger mobility to engage the chip.

Although the previous embodiments are shown with oval shaped chips, the invention is not limited to a particular overall chip shape and can be employed with any chip shape.

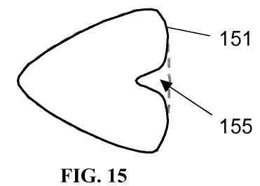

In another exemplary embodiment, as shown in FIG. 15, a triangular shaped chip 151 has a pre-selected portion excluded to form a single triangular notch 155.

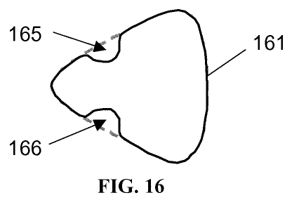

In another exemplary embodiment, as shown in FIG. 16, a triangular shaped chip 161 has a pre-selected portion excluded to form two circular notches 165, 166.

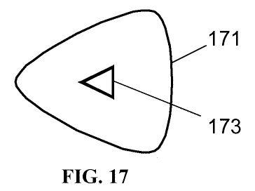

In another exemplary embodiment, as shown in FIG. 17, a triangular shaped chip 171 has a pre-selected portion excluded to form a central triangular hole 173.

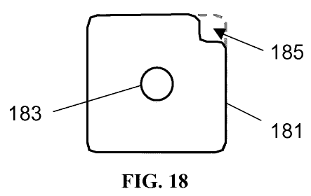

In another exemplary embodiment, as shown in FIG. 18, a rectangular shaped chip 181 has two pre-selected portions excluded to form a single corner rectangular notch 185 and a central circular hole 183.

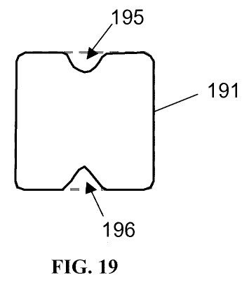

In another exemplary embodiment, as shown in FIG. 19, a rectangular shaped chip 191 has two pre-selected portions excluded to form a lateral side circular notch 195 and a lateral side triangular notch 196.

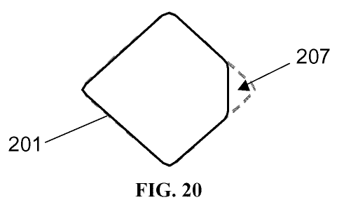

In another exemplary embodiment, as shown in FIG. 20, a diamond shaped chip 201 has a triangular shaped pre-selected portion excluded to form a blunt point 207.

In all of the previously described embodiments, the pre-selected portions that are excluded are described as the approximate size of a human adult finger. However, the size of each pre-selected portion is not limited to a human adult finger and can be approximately the size of an average human teenager''s finger, or an average human child''s finger. Each pre-selected portion can also be any size larger than a human finger.

Although the present invention has been shown and described with respect to several preferred embodiments thereof, various changes, omissions, and additions to the form and detail thereof, may be made therein, without departing from the spirit and scope of the invention.

1. A chip-type snack product of substantially uniform thickness having at least one hole that is at least finger-sized.

2. A chip-type snack product of claim 1 wherein said chip-type snack product comprises a uniform shape.

3. A chip-type snack product of claim 1 wherein said snack has at least one axis of symmetry.

4. A chip-type snack product of claim 1 wherein a shape of said at least one hole is selected from a group comprising circular, elliptical, triangular, rectangular, and polygonal.

5. A chip-type snack product of claim 1 wherein said at least one hole comprises an area of at least 1 cm².

6. A chip-type snack product of claim 1 wherein said at least one hole is centrally located.

7. A chip-type snack product of claim 1 wherein said at least one hole is the approximate size of a human adult fingertip.

8. A chip-type snack product of claim 1 wherein said at least one hole is the approximate size of the diameter of a human adult finger.

9. A chip-type snack product of claim 1 wherein said at least one hole is at least 1 cm in diameter.

10. A chip-type snack product of claim 1 wherein said at least one hole is at least 1 cm in width.

11. A chip-type snack product of claim 1 wherein said at least one hole is at least 1 cm in length.

12. A chip-type snack product of substantially uniform thickness comprising a uniform shape further not comprising at least one at least finger-sized pre-selected portion of said uniform shape.

13. A chip-type snack product of claim 12 wherein a shape of said pre-selected portion is selected from a group comprising circular, elliptical, triangular, rectangular, polygonal, and non-geometrical.

14. A chip-type snack product of claim 12 wherein said chip-type snack product comprises at least one axis of symmetry.

15. A chip-type snack product of claim 12 wherein said pre-selected portion comprises at least one notch.

16. A chip-type snack product of claim 12 wherein said pre-selected portion is the approximate size of a human adult fingertip.

17. A chip-type snack product of claim 12 wherein said pre-selected portion is the approximate size of the diameter of a human adult finger.

18. A chip-type snack product of claim 12 wherein said pre-selected portion comprises an area of at least 1 cm².

19. A method of forming a chip-type snack product wherein an at least finger-sized pre-selected portion of said chip-type snack product is excluded.

20. A method of claim 19 wherein said method comprises a shaping step.

21. A method of claim 20 wherein said shaping step further comprises excluding said pre-selected portion.

22. A method of claim 19 wherein said method comprises a removal step.

23. A method of claim 19 wherein said method comprises a forming step.
